(19) United States
(12) Patent Application Publication
(10) Pub. No.: US 2026/0128589 A1
(43) Pub. Date: May 7, 2026

(54) DIRECT CURRENT VOLTAGE CONTROL METHOD AND SYSTEM FOR ENHANCING TRANSIENT STABILITY OF GRID-CONNECTED CONVERTER

(71) Applicant: SOUTHEAST UNIVERSITY, Nanjing (CN)

(72) Inventors: Zhixiang ZOU, Nanjing (CN); Chenhang XU, Nanjing (CN); Xinlei LIU, Nanjing (CN); Zheng WANG, Nanjing (CN)

(21) Appl. No.: 19/340,710

(22) Filed: Sep. 25, 2025

Related U.S. Application Data
(63) Continuation of application No. PCT/CN2025/077604, filed on Feb. 17, 2025.

(30) Foreign Application Priority Data
Nov. 6, 2024 (CN) 202411573516.5

(51) Int. Cl. H02J 3/00; G05B 9/02; H02J 3/24; H02J 3/38

(52) U.S. Cl. CPC H02J 3/00125; G05B 9/02; H02J 3/00142; H02J 3/38

(57) ABSTRACT

A direct current (DC) voltage control method for enhancing transient stability of a grid-connected converter includes the steps of: processing a control signal of a synchronization control loop by a DC-link transient energy correction module (DC-TECM) when either a power angle limit violation-based fault diagnosis module (PAV-FDM) or a voltage limit violation-based fault diagnosis module (VLV-FDM) determines that a voltage sag or phase jump fault has occurred, and subjecting a DC voltage reference value to temporary storage of unbalanced power and inertia correction; comparing a voltage value of a DC-link capacitor with the DC voltage reference value, and obtaining a DC voltage control output reference value through a steady-state DC voltage control module; obtaining a synchronization control signal and an internal electromotive force reference value; and generating converter driving signals. In the present disclosure, the transient stability issues of the grid-connected converter under grid faults can be effectively addressed.

### CROSS-REFERENCE TO RELATED APPLICATIONS

This application is a continuation of PCT/CN2025/077604, filed on Feb. 17, 2025 and claims priority of Chinese Patent Application No. 202411573516.5, filed on Nov. 6, 2024, the entire contents of which are incorporated herein by reference.

### TECHNICAL FIELD

The present disclosure belongs to the technical field of power system application, and in particular to a direct current (DC) voltage control method and system for enhancing transient stability of a grid-connected converter.

### BACKGROUND

Faced with the challenges of fossil energy depletion and climate and environmental conditions, all countries around the world have implemented various strategies to improve energy structures. These strategies include enhancing energy utilization and vigorously developing clean and renewable energy, all with the aim of ensuring a sustainable energy supply and fostering harmonious economic and social development. The 19th National Congress of the Communist Party of China placed a strong emphasis on ecological civilization construction, urging efforts to promote green, circular and low-carbon development. China has committed to working collaboratively with the international community to actively address climate change. Controlling greenhouse gas emissions and achieving green and low-carbon development are also crucial for China to transform its development mode, overcoming resource and environmental constraints, and enhance its international competitiveness.

With the rapid development of renewable energy power generation technology, renewable energy sources including photovoltaic and wind power are integrated into the same alternating current (AC) power grid through power electronic devices. This integration has resulted in the formation of a multi-source renewable energy feeding system. The grid connection through grid-connected converters has significantly changed the dynamic characteristics of modern power grids, thereby posing challenges to the security and stability of the grid. When the voltage sags and phase jump faults occur in the power grid, the DC-side power of the grid-connected converter may exceed the AC-side output power, creating an unbalanced power condition during the transient process, which can finally lead to the risk of transient power angle instability.

### SUMMARY

An objective of the present disclosure is to provide a DC voltage control method and system for enhancing transient stability of a grid-connected converter, which can effectively solve the stability issue of the grid-connected converter when a transient grid fault occurs.

To achieve the above objective, the present disclosure adopts the following solutions.

A DC voltage control method for enhancing transient stability of a grid-connected converter includes the steps of:
processing a control signal of a synchronization control loop by a DC-link transient energy correction module (DC-TECM) when either a power angle limit violation-based fault diagnosis module (PAV-FDM) or a voltage limit violation-based fault diagnosis module (VLV-FDM) determines that a voltage sag or phase jump fault has occurred, and subjecting a DC voltage reference value to temporary storage of unbalanced power and inertia correction;
acquiring a voltage value of a DC-link capacitor, comparing the voltage value with the DC voltage reference value, and obtaining a DC voltage control output reference value through a steady-state DC voltage control module;
acquiring output data of a converter at a point of common coupling (PCC), and obtaining a synchronization control signal based on the synchronization control loop;
obtaining an internal electromotive force reference value through an internal electromotive force control loop based on the synchronization control signal; and
generating converter driving signals based on the internal electromotive force reference value.

The subjecting a DC voltage reference value to temporary storage of unbalanced power and inertia correction includes the steps of:
acquiring an angular frequency ω of a converter output voltage, filtering a difference between the angular frequency ω and a rated value ωₙ by a notch filter to remove power frequency disturbance, and amplifying the difference by a damping-voltage mapping coefficient k_{D-V} to obtain a DC voltage elevation increment ΔV_{Pu} for temporary storage of transient unbalanced power;
acquiring an angular frequency change rate \dot{ω} of the converter output voltage, filtering the angular frequency change rate \dot{ω} through a low-pass filter (LPF) to remove high-frequency oscillation, and amplifying the angular frequency change rate by an inertia-voltage mapping coefficient k_{J-V} to obtain a DC voltage elevation increment ΔV_{J} for inertia correction of the converter; and
multiplying a sum ΔV_{dc} of the DC voltage elevation increments for the temporary storage of transient unbalanced power and of the inertia correction of the converter with a fault detection signal S_{F}, superimposing the multiplied value to the DC voltage reference value V_{dc_ref}, and regulating the DC voltage.

The inertia-voltage mapping coefficient is designed by setting an inertia correction amount Δ_{J} of swing characteristics of the converter, and the inertia-voltage mapping coefficient is calculated by the following formula: k_{J-V}=Δ_{J}/k_{pdc}, where k_{pdc} is a proportional coefficient in steady-state DC voltage control; and
the damping-voltage mapping coefficient is designed by setting a damping correction amount ΔD of swing characteristics of the converter, and the damping-voltage mapping coefficient is calculated by the following formula: k_{D-V}=(ΔD+k_{idc}−k_{J-V})/k_{pdc}, where k_{idc} is an integral coefficient in steady-state DC voltage control.

The converter is a grid-forming converter (GFM); and acquiring an angular frequency ω of a converter output voltage includes the steps of:
acquiring an output PCC voltage u_{PCC} and an output PCC current i_{PCC} of the converter to obtain an active power;
obtaining the angular frequency ω of the GFM output voltage through active power-phase synchronization control loop based on a difference between the active power and active power reference value; or
the converter is a grid-following converter (GFL); and the acquiring an angular frequency ω of a converter output voltage, includes the steps of:
acquiring an output PCC voltage u_{PCC} of the converter; and
obtaining the angular frequency ω of the GFL output voltage through a phase-locked loop based on the output PCC voltage u_{PCC}.

Determining that a grid voltage sag or phase jump fault has occurred includes the steps of:
considering, when it is determined that the converter has at least one of the following issues: power angle limit violation (PAV) or voltage limit violation (VLV), that the grid voltage sag or phase jump fault occurs, the fault detection signal S_{F} being set to 1, otherwise, the fault detection signal S_{F} being set to 0.

Determining whether the converter triggers PAV includes the steps of:
acquiring a current power angle δ of the grid-connected converter and an initial point δ₀ of the power angle under stable operation conditions, and calculating a difference between the two; and
comparing an absolute value of the difference with a power angle threshold value δₜₕ, and determining that the converter triggers PAV if the absolute value exceeds the power angle threshold value δₜₕ.

Determining whether the converter triggers VLV includes the steps of:
acquiring a difference between a voltage amplitude V of the grid-connected converter and a rated voltage amplitude value Vₙ; and
comparing an absolute value of the difference with a voltage threshold value Vₜₕ, and determining that the converter triggers VLV if the absolute value exceeds the preset voltage threshold value Vₜₕ.

The converter is a GFM; and the acquiring a voltage value V_{dc} of a DC-link capacitor, comparing the voltage value with the DC voltage reference value V_{dc_ref}, and obtaining a DC voltage control output reference value include the steps of:
acquiring the voltage value V_{dc} of the DC-link capacitor, and comparing the voltage value with the DC voltage reference value V_{dc_ref} to generate an active power reference value P_{ref} as a DC voltage control output reference value;
the acquiring output data of a converter at a PCC, and generating a synchronization control signal based on the synchronization control loop include the steps of:
acquiring an output PCC voltage u_{PCC} and an output PCC current i_{PCC} of the converter to obtain an active power Pₑ and a reactive power Qₑ; and
obtaining a phase reference value θ of the output voltage based on a difference between the active power Pₑ and the active power reference value P_{ref}; obtaining a reference value V of an output voltage amplitude of the converter according to a difference between the reactive power Qₑ and a reactive power reference value Q_{ref}; and the synchronization control signal including the phase reference value θ and an amplitude reference value V; and
the obtaining an internal electromotive force reference value through an internal electromotive force control loop based on the synchronization control signal includes the steps of:
applying coordinate transformation to the amplitude reference value V using the phase reference value θ to obtain an output voltage reference value of the converter output voltage in a synchronous reference frame; and
comparing the output PCC voltage u_{PCC} of the converter with the output voltage reference value in the synchronous reference frame, and obtaining the internal electromotive force reference value based on a difference between the two values.

The converter is a GFL; and the acquiring a voltage value of a DC-link capacitor, comparing the voltage value with the DC voltage reference value V_{dc_ref}, and obtaining a DC voltage control output reference value include the steps of:
acquiring the voltage value V_{dc} of the DC-link capacitor, and comparing the voltage value with the DC voltage reference value V_{dc_ref} to generate an active current reference value I_{d-ref} as the DC voltage control output reference value;
the acquiring output data of a converter at a PCC, and generating a synchronization control signal based on the synchronization control loop include the steps of:

acquiring an output PCC voltage u_{PCC} of the converter; and
obtaining the angular frequency ω of the output PCC voltage u_{PCC} using a phase locked loop, and integrating the angular frequency to obtain a voltage phase θ as a synchronization control signal; and
the obtaining an internal electromotive force reference value through an internal electromotive force control loop based on the synchronization control signal includes the steps of:
acquiring an output PCC current i_{PCC} of the converter, and applying coordinate transformation to the current i_{PCC} using the voltage phase θ to obtain an active current I_{d} and a reactive current I_{q} of converter output;
comparing the active current I_{d} of the converter with a preset active current reference value I_{d_ref} to obtain a first difference value; and comparing the reactive current I_{q} of the converter output with a preset reactive current reference value I_{q_ref} to obtain a second difference value; and
obtaining an internal electromotive force reference value using the first and second difference values.

A DC voltage control system for enhancing the transient stability of a grid-connected converter includes:
a PAV-FDM, configured to determine that a voltage sag or phase jump fault occurs in a grid;
a VLV-FDM, configured to determine that a voltage sag or phase jump fault occurs in a grid;
a DC-TECM, configured to process a control signal of a synchronization control loop by the DC-TECM when either the PAV-FDM or the VLV-FDM determines that a voltage sag or phase jump fault has occurred, and subject a DC voltage reference value to temporary storage of unbalanced power and inertia correction;
a steady-state DC voltage control module, configured to acquire a voltage value of a DC-link port capacitor, and obtain a DC voltage control output reference value by comparing the voltage value with the DC voltage reference value;
a synchronization module, configured to acquire output data of a converter at a PCC, and obtain a synchronization control signal based on the synchronization control loop;
an internal electromotive force control module, configured to obtain an internal electromotive force reference value through an internal electromotive force control loop based on the synchronization control signal; and
a pulse width modulation module, configured to generate a converter driving signal according to the internal electromotive force reference value.

After adopting the above solutions, in the present disclosure, aiming at the transient stability issue faced by the renewable energy field including the grid-connected converter under grid fault conditions, the occurrence of the power grid fault is detected in real time based on the power angle and voltage amplitude of the synchronization module of the grid-connected converter. When a fault is detected, a damping correction module and an inertia correction module are activated to realize the instantaneous storage of unbalanced energy at the DC-link of the grid-connected converter in the transient process, thereby avoiding the transient instability issue and the occurrence of DC VLV. The present disclosure does not alter the control structure and performance of the original synchronization strategy of the original grid-connected converter, and only requires the addition of the DC-link compensation loop to the existing control system, which is convenient to realize, and the transient stability of the grid-connected converter is improved without changing its operating characteristics.

Compared with the related art, the present disclosure has the following beneficial effects. In the present disclosure, the control structure is simple, the parameter adjustment is straightforward, and the reference power of the converter in the normal operating state connected to the grid is not affected. There is no need for mode switching between the normal operation state and the fault state. The DC side of the grid-connected converter can be adaptively controlled to temporarily store unbalanced energy at the moment of a transient grid fault, and the instantaneous transient stability enhancement is provided for the grid-connected converter. The transient process can be shortened under transient fault conditions, the system can be restored to a stable running state in a short time, the overshoot of the DC capacitor voltage is reduced, and the overvoltage risk of the DC side is alleviated. Only the power angle, derivative and voltage amplitude thereof in the synchronization module of the grid-connected converter are used as the feedback quantities, which does not depend on time-varying system information including voltage sag depth and line impedance, thereby avoiding the temporary storage energy deviation of DC-link that may be caused by communication delay, improving the rapidity of transient stability support and reducing the complexity and implementation difficulty of control strategy.

### BRIEF DESCRIPTION OF THE DRAWINGS

To clarify the technical solutions of examples in the present disclosure or in the prior art more clearly, the accompanying drawings required in the description of the examples or the prior art are briefly introduced below. Obviously, other drawings can be obtained according to these drawings without creative efforts for those ordinary skilled in the art.

FIG. 1 is a typical system structure and control block diagram of a grid-connected converter according to an example of the present disclosure;

FIG. 2 is a control block diagram of a grid-connected converter with DC-link control according to an example of the present disclosure;

FIG. 3a is a control block diagram of an active power droop synchronization control module;

FIG. 3b is a control block diagram of a virtual synchronous machine control module;

FIG. 3c is a control block diagram of a reactive power droop synchronization control module;

FIG. 3d is a control block diagram of a phase locked loop synchronization control module;

FIG. 4a is a waveform diagram of a DC voltage and a reference value thereof using conventional DC voltage;

FIG. 4b is a waveform diagram of a DC voltage and a reference value thereof using DC voltage control in the present disclosure;

FIG. 4c is a waveform diagram of an actual value and reference value of output active power using conventional DC voltage control;

FIG. 4d is a waveform diagram of an actual value and reference value of output active power using DC voltage control in the present disclosure;

FIG. 4e is a waveform diagram of a converter output power angle (differences between converter phase and grid phase) using conventional DC voltage control; and

FIG. 4f is a waveform diagram of a converter output power angle (differences between converter phase and grid phase) using DC voltage control in the present disclosure.

### REFERENCE NUMERALS AND DENOTATIONS THEREOF

1: power grid; 2: filtering device; and 3: GFM; 4: DC-link; and 4-1: DC-link capacitor; 5: DC voltage control module; and 5-1: steady-state DC voltage control module; 5-2: fault diagnosis module (FDM); 5-2-1: PAV-FDM; and 5-2-2: VLV-FDM; 5-3: DC-TECM; 5-3-1: transient power temporary storage module; 5-3-2: inertia correction module; and 5-3-3: reference voltage superimposer; 6: synchronization module; 6-1-1-1: active power droop synchronization control module; 6-1-1-2: virtual synchronous machine control module; 6-1-2: reactive power droop synchronization control module; and 6-2: phase locked loop synchronization control module; and 7: internal electromotive force control module; and 8: pulse width modulation module.

### DETAILED DESCRIPTION

Technical solutions in the examples of the present disclosure will be described clearly and completely in the following with reference to the attached drawings in the examples of the present disclosure. Obviously, all the described examples are merely some, rather than all examples of the present disclosure. Based on the examples in the present disclosure, all other examples obtained by those ordinary skilled in the art without creative efforts belong to the protection scope of the present disclosure.

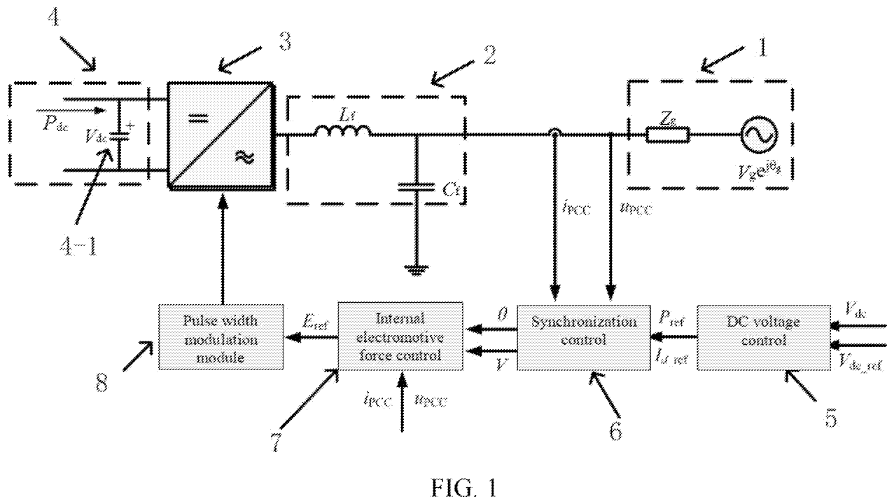

A grid-connected converter applicable to the present disclosure is shown in FIG. 1. The present disclosure includes a GFM 3, a DC-link 4 is arranged on a DC side of the GFM 3, and a DC-link capacitor 4-1 is connected in parallel to the DC-link 4, where P_{dc} represents an active power input of a DC-side front stage, and V_{dc} represents a voltage of a DC-side capacitor; an AC side of the GFM 3 is connected to an infinite power grid 1 through a filtering device 2, the filtering device 2 includes a capacitor L_{f} and a voltage C_{f}, and a connection point after the filtering device becomes a PCC, u_{PCC} and i_{PCC} represent a voltage and a current at the PCC; and the infinite power grid 1 is characterized by a power grid-side impedance Z_{g} and an ideal voltage source V

$${V}_{g}^{e j θ g} .$$

The present disclosure provides a DC voltage control method for enhancing transient stability of a grid-connected converter, including the following steps.

In step 1, when either a PAV-FDM or VLV-FDM determines that the voltage sag or phase jump fault has occurred in the power grid, a control signal of the synchronization control loop is processed by the DC-TECM. The DC voltage reference value is then adjusted for temporary storage of unbalanced power and inertia correction.

In step 2, the voltage value of DC-link capacitor is acquired and compared with the DC voltage reference value, and obtaining the DC voltage control output reference value through the steady-state DC voltage control module.

In step 3, output data of the converter at the PCC is obtained, and the synchronization control signal is obtained through the synchronization control loop.

In step 4, based on the synchronization control signal, an internal electromotive force reference value is obtained according to an internal electromotive force control loop.

In step 5, the converter driving signals are generated based on the internal electromotive force reference value.

Steps 2-5 are typical control steps for existing grid-connected converters. The innovation in the present disclosure lies in the addition of a DC-link compensation loop without affecting the existing control strategy. The DC-link compensation loop of the grid-connected converter is controlled to temporarily store unbalanced energy immediately when the transient grid fault occurs to provide instant transient stability support for the grid-connected converter and improve the rapidity of the transient stability support.

In step 1, the DC voltage reference value is adjusted for both temporary storage of unbalanced power and inertia correction, including the following steps.

The angular frequency ω of the converter output voltage is obtained, the difference between the angular frequency ω and its rated value ωₙ is filtered by a notch filter to remove power frequency disturbance, and amplified by a damping-voltage mapping coefficient k_{D-V} to obtain the DC voltage elevation increment ΔV_{Pu} for temporary storage of transient unbalanced power.

The angular frequency change rate \dot{ω} of the converter output voltage is obtained, the angular frequency change rate \dot{ω} is filtered through an LPF to remove high-frequency oscillation, and amplified by an inertia-voltage mapping coefficient k_{J-V} to obtain the DC voltage elevation increment ΔV_{J} for inertia correction of the converter.

The DC voltage elevation increment for the temporary storage of transient unbalanced power and to the inertia correction of the converter, along with the fault detection signal S_{F} are multiplied to obtain the DC voltage compensation term (ΔV_{dc})², and then superimposed to the DC voltage reference value V_{dc_ref} for correcting the DC voltage.

The inertia-voltage mapping coefficient is designed by setting an inertia correction amount Δ_{J} of the swing characteristic of the converter, and the inertia-voltage mapping coefficient is calculated by the following formula: k_{J-V}=Δj/k_{pdc}, where k_{pdc} is the proportional coefficient in steady-state DC voltage control.

The damping-voltage mapping coefficient is designed by setting a damping correction amount ΔD of the swing characteristic of the converter, and the damping-voltage mapping coefficient is calculated by the following formula: k_{D-V}=(ΔD+k_{idc}·k_{J-V})/k_{pdc}, where k_{idc} is the integral coefficient in steady-state DC voltage control.

The converter is a GFM, and the angular frequency ω of the converter output voltage is obtained, including the following steps.

The output PCC voltage u_{PCC} and the output PCC current i_{PCC} of the converter are sampled to obtain the active power.

Based on the difference between the active power and an active power reference value, the angular frequency ω of the converter output voltage is obtained through active power-phase synchronization control loop; or

The converter is a GFL, and the angular frequency ω of the converter output voltage is obtained, including the following steps.

An output PCC voltage u_{PCC} of the converter is obtained.

Phase locked loop is implemented with the output voltage u_{PCC} to obtain the angular frequency ω of the converter output voltage.

In step 1, determining that the voltage sag or phase jump fault has occurred in the power grid includes the following steps.

When the converter is determined to occur at least one of PAV and VLV, it is considered that the grid voltage sag or phase jump fault occurs, and the fault detection signal S_{F} is set as 1, otherwise the fault detection signal S_{F} is set as 0.

The converter is determined to trigger PAV, including the following steps.

The current power angle δ of the grid-connected converter and an initial point δ₀ of the power angle under stable operation conditions are obtained, and the difference between the two are calculated.

The absolute value of the difference is compared with the power angle threshold value δₜₕ, and if the absolute value exceeds the power angle threshold value δₜₕ, it is determined that the converter has PAV

The converter is determined to trigger VLV including the following steps.

The difference between the voltage amplitude V of the grid-connected converter and the rated voltage amplitude value Vₙ is acquired.

The absolute value of the difference is compared with the preset voltage threshold value Vₜₕ, and if the absolute value exceeds the preset voltage threshold value Vₜₕ, it is determined that the converter has VLV.

The active power-phase synchronization control can adopt various strategies, including the droop control solution, the virtual synchronous machine control solution, and the like, which is not limited to the present example.

The droop control refers to the control strategy that the difference between the active power and its reference value is amplified by an active-frequency droop coefficient Kₚ to obtain the angular frequency ω.

The virtual synchronous machine control refers to the control strategy that the difference between the active power and its reference value is amplified by an inertia coefficient Jₚ and a damping coefficient Dₚ to obtain the angular frequency ω, which aims to simulate the frequency response of the synchronous generator.

The converter is the GFM; and step 2 includes the following steps.

The voltage value V_{dc} of the DC-link capacitor is obtained, and the active power reference value P_{ref} is generated as the DC voltage control output reference value after comparing the voltage value with the DC voltage reference value V_{dc_ref}.

Step 3 includes the following steps.

The output PCC voltage u_{PCC} and the output PCC current i_{PCC} of the converter are acquired to obtain the active power Pₑ and reactive power Qₑ.

The phase reference value θ of the output voltage of the converter is obtained through the difference between the active power Pₑ and active power reference value P_{ref}. The reference value V of output voltage amplitude is obtained through the difference between the reactive power Qₑ and reactive power reference value Q_{ref}. And the synchronization control signal includes the phase reference value θ and amplitude reference value V.

Step 4 includes the following steps.

Coordinate transformation is applied on the amplitude reference value V using the phase reference value θ to obtain the output voltage reference value of the converter output voltage in the synchronous reference frame.

The output PCC voltage u_{PCC} of the converter is compared with the output voltage reference value in the synchronous reference frame, and the internal electromotive force reference value is obtained based on the difference between the two values.

The converter is the GFL; and step 2 includes the following steps.

The voltage value V_{dc} of the DC-link capacitor is acquired, and an active current reference value I_{d_ref} is generated as the DC voltage control output reference value after comparing the voltage value with the DC voltage reference value V_{dc_ref}.

Step 3 includes the following steps.

The output PCC voltage u_{PCC} of the converter is obtained.

Phase locked loop is used to obtain the angular frequency ω of the output voltage u_{PCC} of the converter, and the angular frequency ω is integrated to obtain the voltage phase θ as the synchronization control signal.

Step 4 includes the following steps.

The output PCC current i_{PCC} of the converter is acquired, coordinate transformation is applied to the current i_{PCC} using the voltage phase θ to obtain the active current I_{d} and reactive current I_{q} of the converter output.

The active current of the converter output is compared with the preset active current reference value I_{d_ref} to obtain a first difference value; and the reactive current of the converter output is compared with the preset reactive current reference value I_{q_ref} to obtain a second difference value.

The internal electromotive force reference value is obtained based on the first and second difference values.

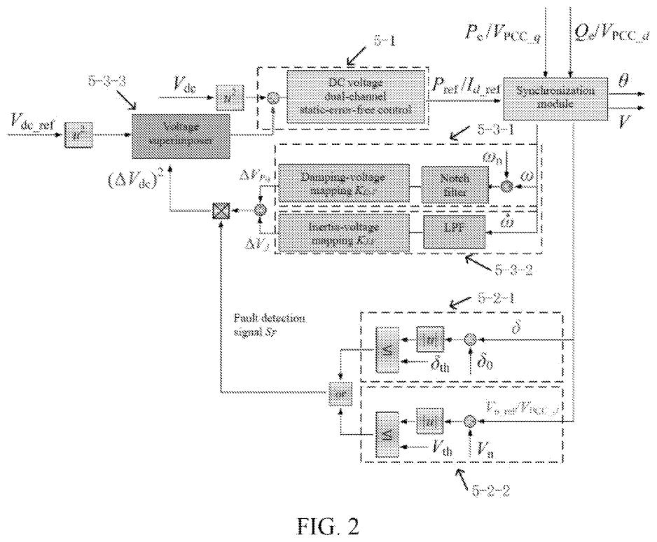

As shown in FIGS. 1 and 2, an example of the present disclosure further provides a DC voltage control system for enhancing the transient stability of the grid-connected converter, including the following modules.

ADC voltage control module 5 is configured to receive the voltage value V_{dc} of the DC-link capacitor, generate the active power or active current reference value after comparing with the DC voltage reference value V_{dc_ref}, and input the active power reference value P_{ref} or the active current reference value I_{d-ref} to the synchronization module 6,

where the DC voltage control module 5 consists of a steady-state DC voltage control module 5-1, an FDM 5-2 and a DC-TECM 5-3; and

the steady-state DC voltage control module 5-1 receives the voltage value V_{dc} of the DC-link capacitor of the converter, calculates the difference with the preset DC voltage reference value V_{dc_ref}, inputs the difference to a dual-channel static-error-free regulator for DC voltage control, and outputs the active power reference value P_{ref} or active current reference value I_{d_ref} at the AC side of the converter.

The FDM 5-2 includes a PAV-FDM 5-2-1 and a VLV-FDM 5-2-2. The PAV-FDM 5-2-1 calculates the difference between the power angle δ by the synchronization module of the grid-connected converter and the initial point δ₀ under stable operation conditions, compares the absolute value of the difference between the power angle δ and the threshold value δₜₕ, and determines that the fault occurs if the absolute value exceeds the threshold value. The VLV-FDM 5-2-2 calculates the difference between the voltage amplitude V of the grid-connected converter and its rated thereof Vₙ, compares the absolute value of the difference between the voltage amplitude V and its threshold voltage value under stable operations, and determines that the fault occurs if the absolute value exceeds the threshold value Vₜₕ. For the grid-connected GFM, the fault occurrence is judged using the output voltage reference value V_{o_ref} of the reactive power droop control in the synchronization module; and for the GFL, the fault occurrence is judged using the d-axis voltage amplitude V_{PCC_d} in the coordinate transformation module.

The PAV-FDM 5-2-1 and the VLV-FDM 5-2-2 operate in parallel, and if any one of the modules triggers the fault signal, it is considered that the grid fault occurs.

The DC-TECM 5-3 includes a transient power temporary storage loop 5-3-1, an inertia correction loop 5-3-2 and a reference voltage superimposer 5-3-3. The transient power temporary storage loop 5-3-1 receives the difference between the angular frequency ω and the rated value thereof ωₙ in the synchronization module 6, and obtains a damping correction amount of the swing characteristic of the grid-connected converter through a damping-voltage mapping link, thereby realizing the temporary storage of the unbalanced power of the AC-link in the DC-link of the converter, and equivalently increasing the unbalanced energy consuming by the damping effect in the transient process. The damping amplification coefficient of the damping-voltage mapping link can be set based on the required damping improvement target, such as 1.5 or 2. The inertia correction module 5-3-2 receives the angular frequency change rate \dot{ω} in the synchronization module 6 with an LPF, and obtains the inertia correction amount of the swing characteristic of the grid-connected converter through the inertia-voltage mapping link, thereby accelerating the transient process of the grid-connected converter, and reducing the voltage rise of the DC-link. The inertia amplification coefficient of the inertia-voltage mapping link can be set based on the required inertia improvement target. The reference voltage superimposer 5-3-3 obtains the sum of the damping correction and the inertia correction results, multiplies it with the fault detection signal S_{F} to obtain the DC voltage compensation term (ΔV_{dc})², and then is added to the DC voltage reference value V_{dc_ref} under the steady state condition through the superimposer to obtain the DC voltage reference value-oriented the AC/DC power balance under grid fault conditions.

The synchronization module 6 is configured to calculate the amplitude and phase of the output voltage or current using the output PCC voltage u_{PCC} and the output PCC current i_{PCC} of the grid-connected converter, and input the amplitude V and phase θ of the converter output voltage or current to the internal electromotive force control module 7.

For the GFM, a power calculation module is configured to calculate the active power and reactive power of the converter output. A grid-forming power synchronization module is configured to calculate the phase of the converter output voltage using the active power value and active power reference value of the GFM output, and calculate the amplitude of the converter output voltage using the reactive power value and reactive power reference value of the GFM output. The amplitude and phase of the converter output voltage are input to the output internal electromotive force control module. For the GFL, a grid-following voltage synchronization module is configured to calculate the voltage phase and amplitude of the grid side using the voltage of the PCC of the converter. The voltage phase and amplitude are sent to the internal electromotive force control module 7.

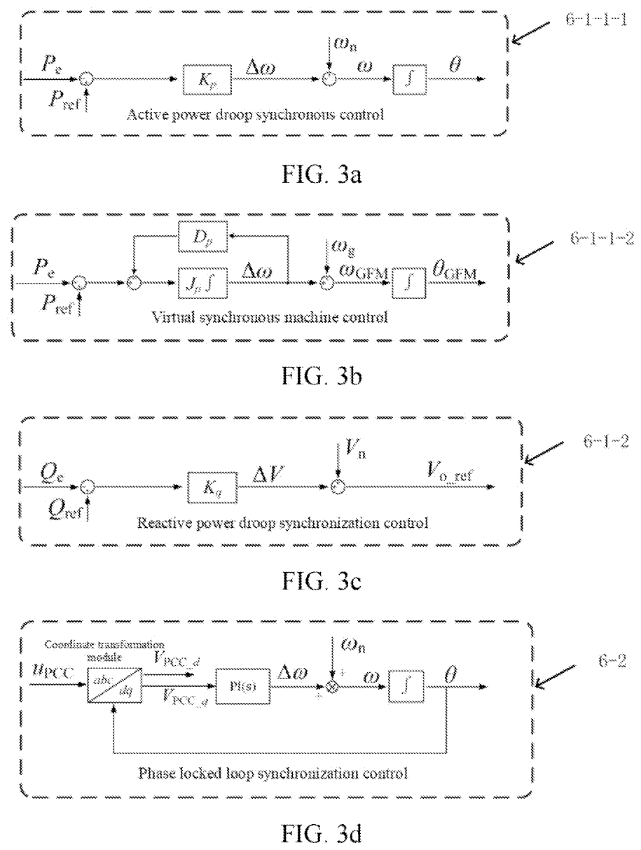

For the power synchronization module of GFM, the active power synchronization module includes droop control, virtual synchronization machine control, and matching control. As shown in FIG. 3, the active power droop synchronization control module 6-1-1-1 amplifies the difference between the active power Pₑ and the active power reference value P_{ref} through the active power-frequency droop coefficient Kₚ to obtain the angular frequency ω. Based on the input of the difference between the active power Pₑ and the active power reference value P_{ref}, the virtual synchronous machine control module 6-1-1-2 simulates the frequency response of the synchronous machine through the inertia coefficient Jₚ and the damping coefficient Dₚ to obtain the angular frequency ω. Besides, based on the difference between the reactive power Qₑ of the converter AC side output and the reference value thereof Q_{ref}, the reactive power droop synchronization control module 6-1-2 uses droop control to generate the amplitude reference value V_{o_ref} of the output voltage via a reactive power droop coefficient K_{q}.

For the voltage synchronization module of the GFL, the PCC voltage u_{PCC} of the GFL is input to a phase locked loop synchronization control module 6-2. After abc/dq coordinate transformation, the q-axis component U_{PCC_q} of the PCC voltage is subjected to proportional-integral controller, then the phase of the PCC voltage is calculated. The amplitude of the PCC voltage is obtained through the d-axis component U_{PCC_d}.

The internal electromotive force control module 7 is configured to generate the internal electromotive force reference value by comparing the phase and amplitude of the converter output voltage or current with the actual value, and to input the internal electromotive force reference value to a pulse width modulation module 8.

For the GFM, the internal electromotive force control module 7 includes a voltage control module and a current control module. The voltage control module compares the voltage reference value of the converter output with the actual value to generate the current reference value, and inputs the current reference value into the current control module. The current control module is configured to generate the internal electromotive force reference value by comparing the current reference value with the actual value, and to input the voltage reference value before the filtering device into the pulse width modulation module. For the GFL, after applying abc dq coordinate transformation, the PCC current is compared with the dq axis current reference value to generate the internal electromotive force reference value E_{ref}.

The pulse width modulation module 8 is configured to generate converter driving signals based on the internal electromotive force reference value.

The effective principles of the present disclosure are as follows.

Under the normal operating conditions of the grid, the power angle and voltage in the converter synchronization module 6 are within the threshold value. Thus, the result of the fault detection module is that there is no grid fault occurs, the output of the fault detection signal and the DC-TECM 5-3 is set to zero. The DC-link of the grid-connected converter works according to the preset DC voltage reference value, and the DC voltage control module does not affect the normal work or dynamic characteristics of the grid-connected converter.

When the grid voltage sag or phase jump fault occurs, the active power of the GFM output changes suddenly at the moment of the fault, which causes a large power difference between the active power of the converter AC side output and the active power reference value, resulting in the rapid increase of the power angle of the synchronization module 6. Similarly, the q-axis voltage of the GFL increases rapidly at the moment of the fault, resulting in the rapid increase of the power angle of the synchronization module 6. At this point, the power angle difference received by the PAV-FDM 5-2-1 exceeds the threshold value, and it is determined that the fault occurs. Since the power angle characteristic is the direct factor causing the transient instability, the PAV-FDM can accurately detect the grid fault. In the same time, the reactive power of the GFM output changes suddenly at the moment of fault, which causes a large power difference between the reactive power of the converter AC side output and the reactive power reference value, resulting in the rapid increase of the voltage amplitude of the synchronization module 6. When the fault occurs, the d-axis voltage in the synchronization module 6 of the GFL changes suddenly at the moment of fault. At this point, the voltage difference received by the VLV-FDM 5-2-2 exceeds the threshold value, and it is determined that the fault occurs. Due to the fast response characteristic of reactive power synchronization module and coordinate transformation module, the VLV-FDM can realize rapid and timely detection of the power grid fault.

When any fault detection module detects a fault, the fault detection signal is set as 1, the DC-TECM 5-3 starts to work, the transient power temporary storage loop 5-3-1 receives the difference between the angular frequency and the rated value thereof in the synchronization module 6, and obtains the DC voltage elevation increment for transient power temporary storage. The inertia correction module 5-3-2 receives the angular frequency change rate in the synchronization module 6 with an LPF, and obtains the DC voltage elevation increment for inertia correction. The sum of the DC voltage elevation increments for transient power temporary storage and for inertia correction is multiplied by the fault detection signal, the DC voltage reference value under transient fault state is raised by the reference voltage superimposer 5-3-3 to modify the DC-link dynamics. Therefore, the DC-link can temporarily store and compensate for the power difference of the converter, reducing the overshoot of power angle and avoiding the potential risk of transient power angle instability. At the same time, the DC voltage is safely limited.

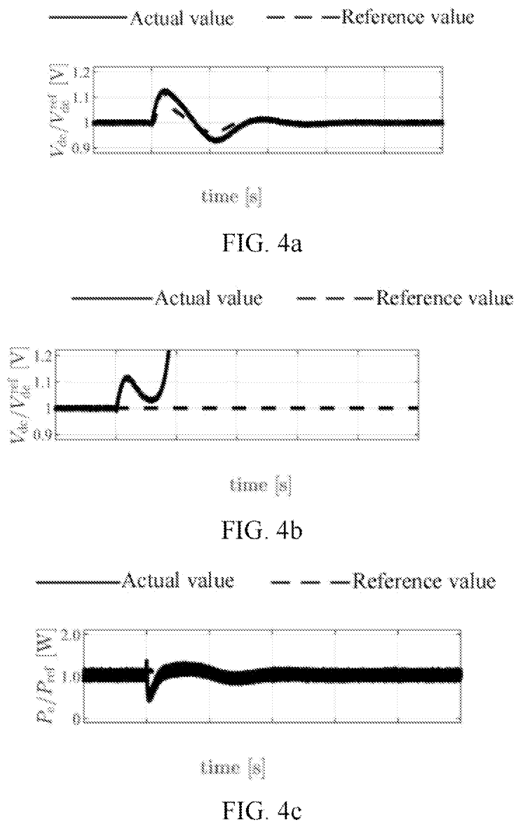

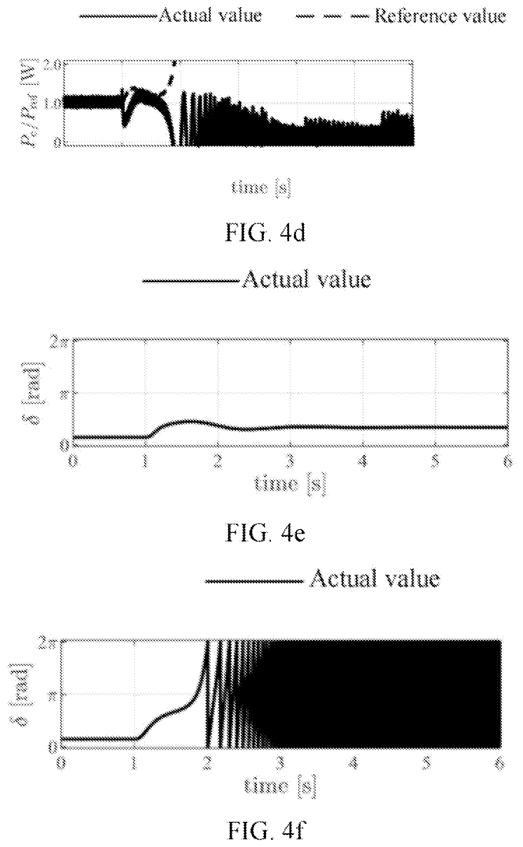

The left and right sides of FIG. 4 show the effects of traditional DC voltage control versus improved DC voltage control. It shows that the DC voltage control method in the present disclosure enables the grid-connected converter to maintain synchronization with the grid under the transient faults, avoiding the risk of transient instability. The control method neither requires mode switching nor affects the steady state operating point of the converter, while it can be triggered at a moment of fault occurrence, thereby avoiding the risk of instability caused by communication delay. This control method also accelerates the transient process of the converter, shortens the overshoot of DC capacitor voltage, and avoids the DC-link overvoltage.

Based on the same inventive concept, the present disclosure also provides a computer device, including one or more processors, and a memory for storing one or more computer programs. The program includes program instructions, and the processor is configured to execute the program instructions stored in the memory. The processor may be a central processing unit (CPU) or other general-purpose processors, a digital signal processor (DSP), an application specific integrated circuit (ASIC), a field-programmable gate array (FPGA) or other programmable logic devices. It may also be a discrete gate or transistor logic device, a discrete hardware component, or the like. The processor serves as the computing core and control core of the terminal for implementing one or more instructions, and in particular, for loading and executing one or more instructions in a computer storage medium to implement the above method.

It is to be further described that, the present disclosure further provides a computer storage medium based on the same inventive concept. A computer program is stored on the storage medium, and when executed by a processor, it performs the above method. The storage medium may employ any combination of one or more computer readable media. The computer readable medium may be a computer readable signal medium or a computer readable storage medium. The computer-readable storage medium may be, for example, but is not limited to, electrical, magnetic, optical, electrical, magnetic, infrared, or semiconductor system, apparatus, or device, or a combination of any of the above. More specific examples (a non-exhaustive list) of computer readable storage media include an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer readable storage medium may be any tangible medium including or storing a program that may be used by or in conjunction with an instruction execution system, apparatus, or device.

In the description of the specification, a description with reference to the terms “one example,” “instance,” “specific instance,” or the like means that a specific feature, structure, material, or characteristic described in connection with the example or instance is included in at least one example or instance of the present disclosure. In this specification, schematic representations of the above terms do not necessarily refer to the same example or instance. Furthermore, the specific features, structures, materials, or characteristics described may be combined in any suitable manner in any one or more examples or instances.

The basic principles, main features, and advantages of the present disclosure are shown and described above. It is to be understood by those skilled in the art that the present disclosure is not limited by the above examples. The above examples and specification only illustrate the principles of the present disclosure, and various changes and improvements can be made to the present disclosure without departing from the spirit and scope of the present disclosure. All these changes and improvements fall within the scope of the present disclosure.

1. A direct current (DC) control method for enhancing transient stability of a grid-connected converter, comprising the steps of:
processing a control signal of a synchronization control loop by a DC-link transient energy correction module (DC-TECM) when either a power angle limit violation-based fault diagnosis module (PAV-FDM) or a voltage limit violation-based fault diagnosis module (VLV-FDM) determines that a voltage sag or phase jump fault has occurred, and subjecting a DC voltage reference value to temporary storage of unbalanced power and inertia correction,
acquiring a voltage value of a DC-link capacitor, comparing the voltage value with the DC voltage reference value, and obtaining a DC voltage control output reference value through a steady-state DC voltage control module,
acquiring output data of a converter at a point of common coupling (PCC), and obtaining a synchronization control signal based on the synchronization control loop,
obtaining an internal electromotive force reference value through an internal electromotive force control loop based on the synchronization control signal, and
generating converter driving signals based on the internal electromotive force reference value, wherein
the subjecting a DC voltage reference value to temporary storage of unbalanced power and inertia correction comprises the steps of:
acquiring an angular frequency ω of a converter output voltage, filtering a difference between the angular frequency ω and a rated value ωₙ by a notch filter to remove power frequency disturbance, and amplifying the difference by a damping-voltage mapping coefficient k_{D-V} to obtain a DC voltage elevation increment ΔV_{Pu} for temporary storage of transient unbalanced power;
acquiring an angular frequency change rate \dot{ω} of the converter output voltage, filtering the angular frequency change rate \dot{ω} through a low-pass filter (LPF) to remove high-frequency oscillation, and amplifying the angular frequency change rate by an inertia-voltage mapping coefficient k_{J-V} to obtain a DC voltage elevation increment ΔV_{J} for inertia correction of the converter; and
multiplying a sum ΔV_{dc} of the DC voltage elevation increments for the temporary storage of transient unbalanced power and of the inertia correction of the converter with a fault detection signal S_{F}, superimposing the multiplied value to the DC voltage reference value V_{dc_ref}, and regulating the DC voltage.

2. The method according to claim 1, wherein the inertia-voltage mapping coefficient is designed by setting an inertia correction amount ΔJ of swing characteristics of the converter, and the inertia-voltage mapping coefficient is calculated by the following formula: k_{J-V}=Δ_{J}/k_{pdc}, where k_{pdc} is a proportional coefficient in steady-state DC voltage control; and
the damping-voltage mapping coefficient is designed by setting a damping correction amount ΔD of swing characteristics of the converter, and the damping-voltage mapping coefficient is calculated by the following formula: k_{D-V}=(ΔD+k_{idc}·k_{J-V})/k_{pdc}, where k_{idc} is an integral coefficient in steady-state DC voltage control.

3. The method according to claim 1, wherein the converter is a grid-forming converter (GFM); and the acquiring an angular frequency ω of a converter output voltage comprises the steps of:
acquiring an output PCC voltage u_{PCC} and an output PCC current i_{PCC} of the converter to obtain an active power;
obtaining the angular frequency ω of the GFM output voltage through active power-phase synchronization control loop based on a difference between the active power and an active power reference value; or
the converter is a grid-following converter (GFL); and the acquiring an angular frequency 0 of a converter output voltage comprises the steps of:
acquiring an output PCC voltage u_{PCC} of the converter; and
obtaining the angular frequency ω of the GFL output voltage through a phase-locked loop based on the output PCC voltage u_{PCC}.

4. The method according to claim 1, wherein determining that a grid voltage sag or phase jump fault has occurred comprises the steps of:
considering, when it is determined that the converter has at least one of the following issues: power angle limit violation (PAV) or voltage limit violation (VLV), that the grid voltage sag or phase jump fault occurs, the fault detection signal S_{F} being set to 1, otherwise, the fault detection signal S_{F} being set to 0.

5. The method according to claim 4, wherein determining whether the converter triggers PAV comprises the steps of:
acquiring a current power angle δ of the grid-connected converter and an initial point δ₀ of the power angle under stable operation conditions, and calculating a difference between the two; and
comparing an absolute value of the difference with a power angle threshold value δₜₕ, and determining that the converter triggers PAV if the absolute value exceeds the power angle threshold value δₜₕ.

6. The method according to claim 4, wherein determining whether the converter triggers VLV comprises the steps of:
acquiring a difference between a voltage amplitude V of the grid-connected converter and a rated voltage amplitude value Vₙ; and
comparing an absolute value of the difference with a voltage threshold value Vₜₕ, and determining that the converter triggers VLV if the absolute value exceeds the preset voltage threshold value Vₜₕ.

7. The method according to claim 1, wherein the converter is a GFM; and the acquiring a voltage value V_{dc} of a DC-link capacitor, comparing the voltage value with the DC voltage reference value V_{dc_ref}, and obtaining a DC voltage control output reference value comprise the steps of:
acquiring the voltage value V_{dc} of the DC-link capacitor, and comparing the voltage value with the DC voltage reference value V_{dc_ref} to generate an active power reference value P_{ref} as a DC voltage control reference value;
the acquiring output data of a converter at a PCC, and generating a synchronization control signal based on the synchronization control loop comprise the steps of:
acquiring an output PCC voltage u_{PCC} and an output PCC current i_{PCC} of the converter to obtain an active power Pₑ and a reactive power Qₑ; and
obtaining a phase reference value θ of the output voltage of the converter based on a difference between the active power Pₑ and the active power reference value P_{ref}; obtaining a reference value V of an output voltage amplitude of the converter according to a difference between the reactive power Qₑ and a reactive power reference value Q_{ref}; and the synchronization control signal comprising the phase reference value θ and an amplitude reference value V; and
the obtaining an internal electromotive force reference value through an internal electromotive force control loop based on the synchronization control signal comprises the steps of:
applying coordinate transformation to the amplitude reference value V using the phase reference value θ to obtain an output voltage reference value of the converter output voltage in a synchronous reference frame; and
comparing the output PCC voltage u_{PCC} of the converter with the output voltage reference value in the synchronous reference frame, and obtaining the internal electromotive force reference value based on a difference between the two values.

8. The method according to claim 1, wherein the converter is a GFL; and the acquiring a voltage value of a DC-link capacitor, comparing the voltage value with the DC voltage reference value V_{dc_ref}, and obtaining a DC voltage control output reference value comprise the steps of:
acquiring the voltage value V_{dc} of the DC-link capacitor, and comparing the voltage value with the DC voltage reference value V_{dc_ref} to generate an active current reference value I_{d_ref} as the DC voltage control output reference value;
the acquiring output data of a converter at a PCC, and generating a synchronization control signal based on the synchronization control loop comprise the steps of:
acquiring an output PCC voltage u_{PCC} of the converter; and
obtaining the angular frequency a of the output PCC voltage u_{PCC} using a phase locked loop, and integrating the angular frequency to obtain a voltage phase θ as a synchronization control signal; and
the obtaining an internal electromotive force reference value through an internal electromotive force control loop based on the synchronization control signal comprises the steps of:
acquiring an output PCC current i_{PCC} of the converter, and applying coordinate transformation to the current i_{PCC} using the voltage phase θ to obtain an active current I_{d} and a reactive current I_{q} of converter output;
comparing the active current I_{d} of the converter with a preset active current reference value I_{d_ref} to obtain a first difference value; and comparing the reactive current I_{q} of the converter output with a preset reactive current reference value I_{q_ref} to obtain a second difference value; and
obtaining an internal electromotive force reference value using the first and second difference values.

9. A DC voltage control system for enhancing transient stability of a grid-connected converter, comprising:
a PAV-FDM, configured to determine that a voltage sag or phase jump fault occurs in a grid,
a VLV-FDM, configured to determine that a voltage sag or phase jump fault occurs in the grid,
a DC-TECM, configured to process a control signal of a synchronization control loop by the DC-TECM when either the PAV-FDM or the VLV-FDM determines that a voltage sag or phase jump fault has occurred, and subject a DC voltage reference value to temporary storage of unbalanced power and inertia correction,
a steady-state DC voltage control module, configured to acquire a voltage value of a DC-link capacitor, and obtain a DC voltage control output reference value by comparing the voltage value with the DC voltage reference value,
a synchronization module, configured to acquire output data of a converter at a PCC, and obtain a synchronization control signal based on the synchronization control loop,
an internal electromotive force control module, configured to obtain an internal electromotive force reference value through an internal electromotive force control loop based on the synchronization control signal, and
a pulse width modulation module, configured to generate a converter driving signal according to the internal electromotive force reference value, wherein
the subjection of a DC voltage reference value to temporary storage of unbalanced power and inertia correction comprises:
acquisition of an angular frequency ω of a converter output voltage, filtering of a difference between the angular frequency ω and a rated value ωₙ by a notch filter to remove power frequency disturbance, and amplification of the difference by a damping-voltage mapping coefficient k_{D-V} to obtain a DC voltage elevation increment ΔV_{Pu} for temporary storage of transient unbalanced power;
acquisition of an angular frequency change rate \dot{ω} of the converter output voltage, filtering of the angular frequency change rate \dot{ω} through an LPF to remove high-frequency oscillation, and amplification of the angular frequency change rate by an inertia-voltage mapping coefficient k_{J-V} to obtain a DC voltage elevation increment ΔV_{J} for inertia correction of the converter; and
multiplication of a sum ΔV_{dc} of the DC voltage elevation increments for temporary storage of transient unbalanced power and of the inertia correction of the converter with a fault detection signal S_{F}, superimposition of the multiplied value to the DC voltage reference value V_{dc_ref}, and regulation of the DC voltage.
